(19) United States
(12) Patent Application Publication
(10) Pub. No.: US 2026/0336400 A1
(43) Pub. Date: Oct. 29, 2026

(54) THEME APPLICATION METHOD, ELECTRONIC DEVICE, AND COMPUTER-READABLE STORAGE MEDIUM

(71) Applicant: XG TECH PTE. LTD., Singapore (SG)

(72) Inventors: Tao LIN, Singapore (SG); Dingwei LIN, Singapore (SG); Wenxiao HU, Singapore (SG); Yiwei DONG, Singapore (SG)

(73) Assignee: XG TECH PTE. LTD., Singapore (SG)

(21) Appl. No.: 19/633,237

(22) Filed: Mar. 30, 2026

(30) Foreign Application Priority Data
Nov. 20, 2025 (CN) 202511717069.0

(51) Int. Cl. B60K 35/21; B60K 35/26; G06T 11/60

(52) U.S. Cl. CPC B60K 35/21; B60K 35/26; G06T 11/60

(57) ABSTRACT

Disclosed are a theme application method, an electronic device, and a computer-readable storage medium. The method includes: in response to a pre-trigger condition of a preset event being satisfied, obtaining vehicle operation data and a theme generation element corresponding to the preset event; determining a theme generation strategy corresponding to the preset event based on the vehicle operation data; generating a theme asset corresponding to the preset event by using the theme generation strategy based on the theme generation element, and preloading the theme asset into an internal memory of an in-vehicle system; and in response to a pre-trigger condition of the preset event being satisfied, invoking the preloaded theme asset from the internal memory of the in-vehicle system, and applying the theme asset.

### CROSS-REFERENCE TO RELATED APPLICATION

This application claims priority to and the benefit of Chinese Patent Application Serial. No. 202511717069.0 filed on Nov. 20, 2025, incorporated herein by reference.

### FIELD OF THE INVENTION

The present disclosure relates to the technical field of intelligent driving, and in particular, to a theme application method and apparatus, an electronic device, and a computer-readable storage medium.

### BACKGROUND OF THE INVENTION

With rapid development of intelligent driving technologies, in-vehicle human-machine interaction systems have become a core hub for interaction between users and intelligent driving vehicles, and design quality thereof directly affects driving experience of the users. A surrounding reality (SR) visualization interface, as a core component of the in-vehicle human-machine interaction system, undertakes an important function of displaying environmental information surrounding the intelligent driving vehicle to the user accurately in a real-time manner.

However, a visual theme style of the SR visualization interface, once set, remains unchanged for a long period of time, presenting strong instrumental and functional characteristics. Although such a visual theme style of the SR visualization interface can ensure accurate transmission of environmental information, it is difficult to respond to requirements of the user for personalized and emotionalized experience, resulting in poor driving experience for the user. Therefore, there is an urgent need for a method capable of dynamically adjusting the visual theme style of the SR visualization interface.

### SUMMARY OF THE INVENTION

To resolve the foregoing technical problem, the present disclosure provides a theme application method and apparatus, an electronic device, and a computer-readable storage medium, which are capable of dynamically adjusting a visual theme style of a human-machine interaction interface based on a preset event, so as to respond to requirements of a user for personalized and emotionalized experience, thereby improving driving experience of the user.

According to an embodiment of a first aspect of the present disclosure, a theme application method is provided, including:
in response to a pre-trigger condition of a preset event being satisfied, obtaining vehicle operation data and a theme generation element corresponding to the preset event;
determining a theme generation strategy corresponding to the preset event based on the vehicle operation data;
generating a theme asset corresponding to the preset event by using the theme generation strategy based on the theme generation element, and preloading the theme asset into an internal memory of an in-vehicle system; and
in response to a pre-trigger condition of the preset event being satisfied, invoking the preloaded theme asset from the internal memory of the in-vehicle system, and applying the theme asset.

According to an embodiment of a second aspect of the present disclosure, a theme application apparatus is provided, including:
an event pre-determining module, configured to, in response to a pre-trigger condition of a preset event being satisfied, obtain vehicle operation data and a theme generation element corresponding to the preset event;
a strategy determining module, configured to determine a theme generation strategy corresponding to the preset event based on the vehicle operation data;
a theme generation module, configured to generate a theme asset corresponding to the preset event by using the theme generation strategy based on the theme generation element, and preload the theme asset into an internal memory of an in-vehicle system; and
a theme application module, configured to, in response to a pre-trigger condition of the preset event being satisfied, invoke the preloaded theme asset from the internal memory of the in-vehicle system, and apply the theme asset.

According to an embodiment of a third aspect of the present disclosure, a computer-readable storage medium is provided, where a computer program is stored on the storage medium, and the computer program, when executed by a processor, causes the processor to implement the theme application method provided in the embodiment of the first aspect.

According to an embodiment of a fourth aspect of the present disclosure, an electronic device is provided, where the electronic device includes: a processor; and a memory configured to store instructions executable by the processor, where the processor is configured to read the executable instructions from the memory, and execute the instructions to implement the theme application method provided in the embodiment of the first aspect.

According to an embodiment of a fifth aspect of the present disclosure, a computer program product is provided, where instructions in the computer program product, when executed by a processor, cause the processor to implement the theme application method provided in the embodiment of the first aspect of the present disclosure.

The embodiments of the present disclosure provide a theme application method and apparatus, an electronic device, and a computer-readable storage medium. In response to the pre-trigger condition of the preset event being satisfied, the electronic device obtains the vehicle operation data and the theme generation element corresponding to the preset event. Subsequently, the electronic device determines the theme generation strategy corresponding to the preset event based on the vehicle operation data. Thereafter, the electronic device generates the theme asset corresponding to the preset event by using the theme generation strategy based on the theme generation element, and preloads the theme asset into the internal memory of the in-vehicle system. Finally, in response to the trigger condition of the preset event being satisfied, the electronic device invokes the preloaded theme asset from the internal memory of the in-vehicle system, and applies the theme asset. In this way, the electronic device can dynamically adjust the visual theme style of the human-machine interaction interface based on the preset event, so as to respond to the requirements of the user for personalized and emotionalized experience, thereby improving the driving experience of the user.

### BRIEF DESCRIPTION OF THE DRAWINGS

FIG. 1 is a schematic diagram illustrating an application scenario of a theme application method according to an exemplary embodiment of the present disclosure;

FIG. 2 is a schematic flowchart illustrating a theme application method according to an exemplary embodiment of the present disclosure;

FIG. 3 is a schematic flowchart illustrating a theme application method according to another exemplary embodiment of the present disclosure;

FIG. 4 is a schematic flowchart illustrating a theme application method according to still another exemplary embodiment of the present disclosure;

FIG. 5 is a schematic flowchart illustrating a theme application method according to yet another exemplary embodiment of the present disclosure;

FIG. 6 is a schematic flowchart illustrating a theme application method according to still yet exemplary embodiment of the present disclosure;

FIG. 7 is a schematic flowchart illustrating a theme application method according to a further exemplary embodiment of the present disclosure;

FIG. 8 is a schematic flowchart illustrating a theme application method according to a still further exemplary embodiment of the present disclosure;

FIG. 9 is a schematic diagram illustrating a structure of a theme application apparatus according to an exemplary embodiment of the present disclosure; and

FIG. 10 is a diagram illustrating a structure of an electronic device according to an exemplary embodiment of the present disclosure.

### DETAILED DESCRIPTION OF THE EMBODIMENTS

To explain the present disclosure, exemplary embodiments of the present disclosure will be described in detail below with reference to the accompanying drawings. Obviously, the described embodiments are merely some, not all, of embodiments of the present disclosure. It should be understood that the present disclosure is not limited by the exemplary embodiments.

It should be noted that, unless otherwise specifically stated, the relative arrangements of components and steps, numerical expressions, and numerical values set forth in these embodiments do not limit the scope of the present disclosure.

### Application Overview

Intelligent driving described in the present disclosure may encompass a plurality of fields such as automatic driving, assisted driving, and robot systems. Automatic driving technologies are dedicated to implementing fully autonomous driving of vehicles in various complex road conditions without human intervention, and are also referred to as unmanned driving, being an advanced form of intelligent driving. The assisted driving provides, through a series of sensors and algorithms, drivers with real-time road condition information, warnings, and partial driving operation support, such as automatic parking and adaptive cruise control, to improve driving safety and convenience. The robot systems further apply the intelligent driving technologies to fields such as service robots and industrial robots, so that robots can autonomously navigate, avoid obstacles, and complete specific tasks in complex environments, such as logistics delivery and warehouse management, demonstrating broad application potential of the intelligent driving technologies in different scenarios.

With rapid development of the intelligent driving technologies, in-vehicle human-machine interaction systems have become a core hub for interaction between users and intelligent driving vehicles, and design quality thereof directly affects driving experience of the users. A surrounding reality (SR) visualization interface, as a core component of the in-vehicle human-machine interaction system, undertakes an important function of displaying environmental information surrounding the intelligent driving vehicle to the user accurately in a real-time manner.

However, a visual theme style of the SR visualization interface, once set, remains unchanged for a long period of time, presenting strong instrumental and functional characteristics. Although such a visual theme style of the SR visualization interface can ensure accurate transmission of environmental information, it is difficult to respond to requirements of the user for personalized and emotionalized experience, resulting in poor driving experience for the user.

Embodiments of the present disclosure provide a theme application method. In response to a pre-trigger condition of a preset event being satisfied, an electronic device obtains, vehicle operation data and a theme generation element corresponding to the preset event. Subsequently, the electronic device determines a theme generation strategy corresponding to the preset event based on the vehicle operation data. Thereafter, the electronic device generates a theme asset corresponding to the preset event by using the theme generation strategy based on the theme generation element, and preloads the theme asset into an internal memory of an in-vehicle system (such as an in-vehicle infotainment system). Finally, in response to a pre-trigger condition of the preset event being satisfied, the electronic device invokes the preloaded theme asset from the internal memory of the in-vehicle system, and applies the theme asset. In this way, the electronic device can dynamically adjusting a visual theme style of a human-machine interaction interface based on the preset event, so as to respond to the requirements of the user for personalized and emotionalized experience, thereby improving the driving experience of the user.

### Exemplary System

FIG. 1 is a schematic diagram illustrating an application scenario of a theme application method according to an exemplary embodiment of the present disclosure. As shown in FIG. 1, the application scenario includes an intelligent driving vehicle 110 and a cloud server 120. The intelligent driving vehicle 110 is connected to the cloud server 120 through a wireless network. First, an electronic device in the intelligent driving vehicle 110 periodically determines whether a preset event in an event database satisfies a corresponding pre-trigger condition. Subsequently, in response to the pre-trigger condition of the preset event being satisfied, the electronic device obtains vehicle operation data and a theme generation element corresponding to the preset event. Thereafter, the electronic device determines a theme generation strategy corresponding to the preset event based on the vehicle operation data. Further, in response to the theme generation strategy corresponding to the preset event being a theme local generation strategy, the electronic device invokes a processing unit of the intelligent driving vehicle 110 to generate theme asset corresponding to the preset event based on the theme generation element. In response to the theme generation strategy corresponding to the preset event being a theme cloud generation strategy, the electronic device transmits a theme generation request message carrying the theme generation element to the cloud server 120. The cloud server 120 generates the theme asset corresponding to the preset event based on the theme generation element carried in the theme generation request message, and sends a theme generation response message carrying an asset storage path of the theme asset to the electronic device. The electronic device downloads the theme asset corresponding to the preset event from the cloud server 120 based on the asset storage path. After obtaining the theme asset corresponding to the preset event, the electronic device may preload the theme asset corresponding to the preset event into an internal memory of an in-vehicle system before the preset event is triggered. Finally, in response to a pre-trigger condition of the preset event being satisfied, the electronic device invokes the preloaded theme asset from the internal memory of the in-vehicle system, and applies the theme asset.

### Exemplary Method

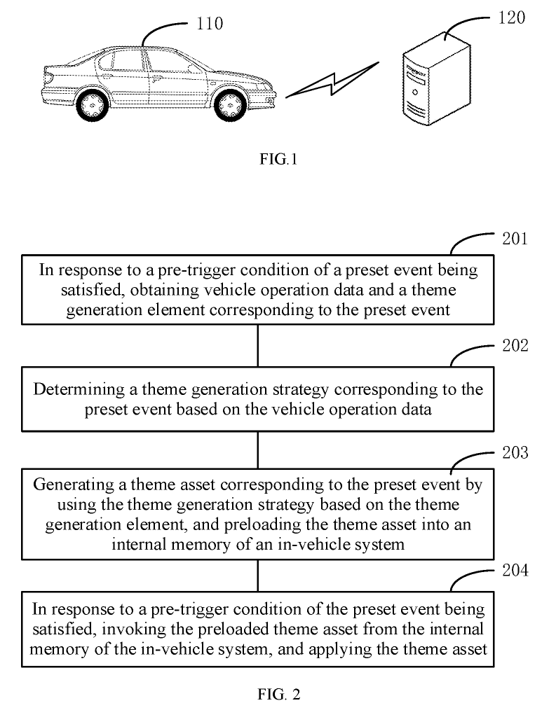

FIG. 2 is a schematic flowchart illustrating a theme application method according to an exemplary embodiment of the present disclosure. The present embodiment may be applied to an electronic device. As shown in FIG. 2, the method includes the following steps.

Step 201: In response to a pre-trigger condition of a preset event being satisfied, obtaining vehicle operation data and a theme generation element corresponding to the preset event.

For example, an event database for storing preset events, pre-trigger conditions, trigger conditions, and theme generation elements may be pre-stored in the electronic device. The preset events generally include two types of events. A first type of event is a deterministic event, such as a Gregorian or lunar calendar holiday (such as New Year's Day, the Spring Festival, the Dragon Boat Festival, or Labor Day), a Western holiday (such as Thanksgiving or Christmas), or a personal anniversary of a user (such as birthday or wedding anniversary). A second type of event is an uncertain event, such as a weather event (such as rainy weather or snowy weather) or a news event (such as a sports event). Descriptions are made in this embodiment of the present disclosure merely by using an example in which the preset event includes the foregoing two types of events, without limiting the preset event. A person skilled in the art may fully add or delete the preset events in the event database based on an actual situation, which is not limited in this embodiment of the present disclosure.

Different preset events correspond to different pre-trigger conditions. The pre-trigger condition corresponding to the preset event refers to a condition for the electronic device to determine, before the preset event is triggered, whether to generate the theme asset corresponding to the preset event in advance. The electronic device may periodically determine whether the preset event in the event database satisfies the corresponding pre-trigger condition. If a certain preset event satisfies the corresponding pre-trigger condition, the electronic device may obtain, in response to the preset event satisfying the corresponding pre-trigger condition, the vehicle operation data and the theme generation element corresponding to the preset event. The vehicle operation data may include in-vehicle operation data (such as an in-vehicle load rate and in-vehicle wireless signal power) and a vehicle operating status (such as a driving status and a parking status), and may also include other types of vehicle operation data. This is not limited in this embodiment of the present disclosure. The theme generation element corresponding to the preset event refer to a generation element required for generating the theme asset corresponding to the preset event. The theme generation elements may include an event name, an event description, and a theme style, and may also include other information, which is not limited in this embodiment of the present disclosure. The theme generation element corresponding to the preset event may be generated through a neural network model or through user input, which is not limited in this embodiment of the present disclosure. For example, the preset event is the Dragon Boat Festival, and in the theme generation element corresponding to the Dragon Boat Festival: the event name is: "Dragon Boat Festival"; the event description is: "eating zongzi, dragon boat racing, wearing sachets"; and the theme style is: "traditional Chinese style". For another example, the preset event is a wedding anniversary, and in the theme generation element corresponding to the wedding anniversary: the event name is: "Wedding Anniversary"; the event description is: "5th anniversary, the lady likes lilies and fireworks"; and the theme style is: "romantic starry sky style". The processing of obtaining the vehicle operation data and the theme generation element corresponding to the preset event by the electronic device in response to the pre-trigger condition of the preset event being satisfied may be described in detail later, and details are not described herein.

Step 202: Determining a theme generation strategy corresponding to the preset event based on the vehicle operation data.

For example, the electronic device may require a large amount of computational resources to generate the theme asset corresponding to the preset event based on theme generation element. To avoid adverse effects on driving safety of an intelligent driving vehicle, the electronic device, after obtaining the vehicle operation data, may determine the theme generation strategy corresponding to the preset event based on the vehicle operation data. The theme generation strategy may include a theme local generation strategy and a theme cloud generation strategy. The theme local generation strategy means that the electronic device uses a processing unit (such as an NPU or a GPU) of the intelligent driving vehicle to generate the theme asset corresponding to the preset event. The theme cloud generation strategy means that the electronic device uses a cloud server to generate the theme asset corresponding to the preset event, and after the theme asset is generated by the cloud server, the electronic device only needs to download the generated theme asset. The processing of determining the theme generation strategy corresponding to the preset event based on the vehicle operation data by the electronic device may be described in detail later, and details are not described herein.

Step 203: Generating a theme asset corresponding to the preset event by using the theme generation strategy based on the theme generation element, and preloading the theme asset into an internal memory of an in-vehicle system.

For example, after determining the theme generation strategy corresponding to the preset event, the electronic device may generate the theme asset corresponding to the preset event by using the theme generation strategy based on the theme generation element. For a case where the theme generation strategy corresponding to the preset event is the theme local generation strategy, the electronic device may invoke the processing unit of the intelligent driving vehicle itself to generate the theme asset corresponding to the preset event based on the theme generation element. For example, taking the preset event being the Dragon Boat Festival as an example, the electronic device may invoke the processing unit of the intelligent driving vehicle itself to generate the theme asset corresponding to the Dragon Boat Festival based on the theme generation element corresponding to the Dragon Boat Festival. The theme asset corresponding to the Dragon Boat Festival includes a dragon boat-shaped three-dimensional model for other vehicles, an ink painting-style road texture map, a zongzi-shaped pendant model, and the like.

For a case where the theme generation strategy corresponding to the preset event is the theme cloud generation strategy, the electronic device transmits a theme generation request message carrying the theme generation element to the cloud server. The cloud server generates the theme asset corresponding to the preset event based on the theme generation element carried in the theme generation request message, and sends a theme generation response message carrying an asset storage path of the theme asset to the electronic device. The electronic device downloads the theme asset corresponding to the preset event from the cloud server based on the asset storage path. For example, taking the preset event being a wedding anniversary as an example, the theme asset corresponding to the wedding anniversary that is generated by the cloud server based on the theme generation element carried in the theme generation request message includes: a three-dimensional model with a "stardust" light effect dynamic skin for an ego vehicle, a brilliant and colorful Roman numeral "V" at front or rear of the vehicle, a wishing tree model, a skybox texture map with a night sky filled with stars and a brilliant Milky Way, and fireworks show animations.

Further, since the theme asset typically contains large-volume file data such as three-dimensional models, skybox texture maps, and road texture maps, to avoid delay and lag caused by the electronic device temporarily loading the theme asset corresponding to the preset event when the preset event is triggered, the electronic device, after obtaining the theme asset corresponding to the preset event, may preload the theme asset corresponding to the preset event into the internal memory of the in-vehicle system before the preset event is triggered. Specifically, the electronic device may preload the theme asset corresponding to the preset event into the internal memory of the in-vehicle system before the preset event is triggered and during an idle period of the intelligent driving vehicle (such as a nighttime parking period or a charging period). The internal memory of the in-vehicle system may be a memory, a cache, or another type of internal memory, which is not limited in this embodiment of the present disclosure.

Step 204: In response to a pre-trigger condition of the preset event being satisfied, invoking the preloaded theme asset from the internal memory of the in-vehicle system, and applying the theme asset.

For example, different preset events correspond to different trigger conditions. The trigger condition corresponding to the preset event refers to a condition met when the preset event is triggered. The electronic device may periodically determine whether the preset event in the event database satisfies the corresponding trigger condition. If a certain preset event satisfies the corresponding trigger condition, the electronic device, in response to the trigger condition of the preset event being satisfied, may invoke the preloaded theme asset from the internal memory of the in-vehicle system, and apply the theme asset. In one embodiment, in response to the trigger condition of the preset event being satisfied, the electronic device displays a theme application prompt in a human-machine interaction interface when the intelligent driving vehicle is started by the user. For example, taking the preset event being the Dragon Boat Festival as an example, a current date is a trigger date of the Dragon Boat Festival, that is, 2025/5/31, and when the intelligent driving vehicle is started by the user, the electronic device displays a theme application prompt in the human-machine interaction interface: "Happy Dragon Boat Festival! A festival exclusive theme has been prepared for you. Would you like to experience it now?" In response to a confirmation operation of the user on the theme application prompt, the electronic device invokes the preloaded theme asset from the internal memory of the in-vehicle system, and applies the theme asset. Since the electronic device has preloaded the theme asset corresponding to the preset event into the internal memory of the in-vehicle system before the preset event is triggered, the electronic device, in response to the confirmation operation of the user on the theme application prompt, may directly invoke the preloaded theme asset from the internal memory of the in-vehicle system and apply the theme asset, thereby avoiding delay and lag caused by temporarily loading the theme asset corresponding to the preset event.

In this embodiment of the present disclosure, in response to the trigger condition of the preset event being satisfied, the electronic device invokes the preloaded theme asset from the internal memory of the in-vehicle system, and applies the theme asset. In this way, the electronic device can dynamically adjust a visual theme style of the human-machine interaction interface based on the preset event, so as to respond to requirements of the user for personalized and emotionalized experience, thereby improving driving experience of the user.

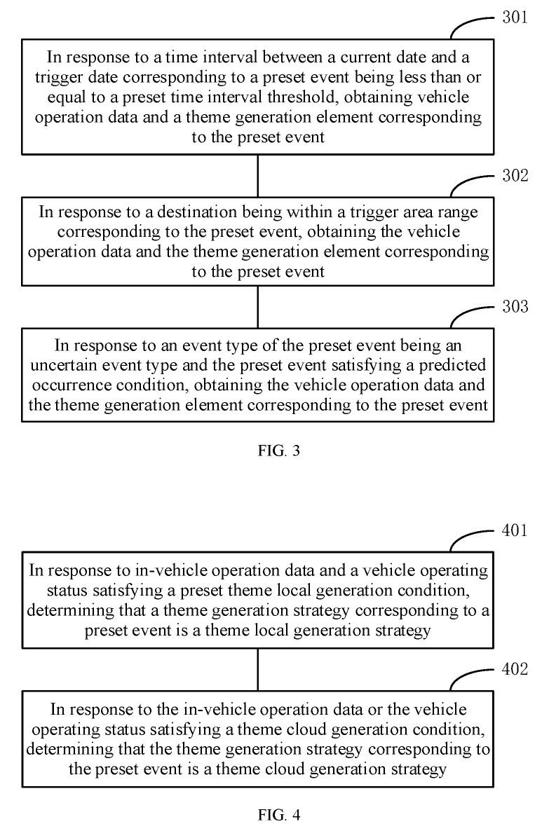

In some embodiments, as shown in FIG. 3, on the basis of the embodiment shown in FIG. 2, Step 201 may include the following steps.

Step 301: In response to a time interval between a current date and a trigger date corresponding to the preset event being less than or equal to a preset time interval threshold, obtaining the vehicle operation data and the theme generation element corresponding to the preset event.

For example, different preset events correspond to different pre-trigger conditions, and the processing of determining whether the preset event satisfies the corresponding pre-trigger condition by the electronic device also varies. For a holiday-type preset event, the corresponding pre-trigger condition may be set as the time interval between the current date and the trigger date corresponding to the preset event being less than or equal to the preset time interval threshold. Therefore, the electronic device may obtain the current date and the trigger date corresponding to the preset event. Subsequently, the electronic device may further calculate the time interval between the current date and the trigger date corresponding to the preset event, that is, the time interval = the trigger date corresponding to the preset event - the current date. If the time interval is less than or equal to the preset time interval threshold, the electronic device determines that the preset event satisfies corresponding pre-trigger condition. Accordingly, the electronic device may obtain the vehicle operation data and the theme generation element corresponding to the preset event. If the time interval is greater than the preset time interval threshold, the electronic device determines that the preset event does not satisfy the corresponding pre-trigger condition. Accordingly, the electronic device may continue to determine, in a next cycle, whether the preset event satisfies the corresponding pre-trigger condition. For example, the preset event is the Dragon Boat Festival, the trigger date corresponding to the Dragon Boat Festival is 2025/05/31, the time interval threshold is 7 days, the current date is 2025/05/25, and the time interval = 2025/05/31 - 2025/05/25 = 7 days. The time interval (7 days) is less than or equal to the time interval threshold (7 days), and the electronic device determines that the pre-trigger condition corresponding to the Dragon Boat Festival is satisfied. For another example, the preset event is a wedding anniversary, the trigger date corresponding to the wedding anniversary is 2025/08/08, the time interval threshold is 7 days, the current date is 2025/06/20, and the time interval = 2025/08/08 - 2025/06/20 = 50 days. The time interval (50 days) is greater than the time interval threshold (7 days), and the electronic device determines that the pre-trigger condition corresponding to the wedding anniversary is not satisfied.

Step 302: In response to a destination being within a trigger area range corresponding to the preset event, obtaining the vehicle operation data and the theme generation element corresponding to the preset event.

For example, for a geographical location-type preset event, the corresponding pre-trigger condition may be set as the destination being within the trigger area range corresponding to the preset event. The trigger area range corresponding to the preset event is a polygonal geofence formed by a series of location points. Therefore, the electronic device may obtain a destination location in vehicle navigation data and the trigger area range corresponding to the preset event. Subsequently, the electronic device may determine whether the destination location is within the trigger area range corresponding to the preset event. If the destination location is within the trigger area range corresponding to the preset event, the electronic device determines that the preset event satisfies the corresponding pre-trigger condition. Accordingly, the electronic device may obtain the vehicle operation data and the theme generation element corresponding to the preset event. If the destination location is outside the trigger area range corresponding to the preset event, the electronic device determines that the preset event does not satisfy the corresponding pre-trigger condition. Accordingly, the electronic device does not need to perform other processing. For example, the preset event is to visit a Theme Park A, and when a destination in the navigation data is within a geofence of the Theme Park A, the electronic device determines that the pre-trigger condition corresponding to visit of the Theme Park A is satisfied.

It should be noted that descriptions are made in the embodiments of the present disclosure merely by using an example in which the pre-trigger condition corresponding to the geographical location-type preset event being set as the destination being within the trigger area range corresponding to the preset event. A person skilled in the art may also set the pre-trigger condition corresponding to the geographical location-type preset event as a waypoint location being within the trigger area range corresponding to the preset event, or set the pre-trigger condition corresponding to the geographical location-type preset event as a current location being within the trigger area range corresponding to the preset event. This is not limited in the embodiments of the present disclosure.

Step 303: In response to an event type of the preset event being an uncertain event type and the preset event satisfying a predicted occurrence condition, obtaining the vehicle operation data and the theme generation element corresponding to the preset event.

For example, for an uncertain event-type preset event, the corresponding pre-trigger condition may be set as the preset event satisfying the predicted occurrence condition. The predicted occurrence condition corresponding to the preset event refers to predicting that the preset event may occur in the future. Therefore, the electronic device may obtain public dynamic information in a real-time manner. Subsequently, the electronic device may determine, based on the public dynamic information, whether the preset event satisfies the predicted occurrence condition. If the preset event satisfies the predicted occurrence condition, the electronic device determines that the preset event satisfies the corresponding pre-trigger condition. Accordingly, the electronic device may obtain the vehicle operation data and the theme generation element corresponding to the preset event. If the preset event does not satisfy the predicted occurrence condition, the electronic device determines that the preset event does not satisfy the corresponding pre-trigger condition. Accordingly, the electronic device does not need to perform other processing. For example, the preset event is snowy weather, the electronic device may obtain weather forecast information, and predict, based on the weather forecast information, that snowy weather may occur in coming days. In this case, the electronic device determines that the pre-trigger condition corresponding to the snowy weather is satisfied.

It should be noted that an execution order of the foregoing steps 301 to 303 is not a serial execution order, but a parallel execution order. In other words, the electronic device may determine, in parallel and based on different preset events, whether the preset event satisfies the corresponding pre-trigger condition.

In the embodiments of the present disclosure, different preset events correspond to different pre-trigger conditions. For different preset events, the electronic device uses different processing methods to determine whether the preset events satisfy the corresponding pre-trigger conditions, and obtains the vehicle operation data and theme generation element corresponding to the preset events when the preset events satisfy the corresponding pre-trigger condition, thereby greatly increasing types of preset events that can be covered. Meanwhile, this embodiment of the present disclosure can support the geographical location-type preset event and the uncertain event-type preset event. The two types of preset events may closely associate themes with a real geographical environment and a real-time event occurring in the future of the user, thereby providing the user with more dynamic and immersive user experience.

In some embodiments, as shown in FIG. 4, on the basis of the embodiment shown in FIG. 2, the vehicle operation data includes one or more of the in-vehicle operation data and the vehicle operating status. Step 202 may include the following steps.

Step 401: In response to the in-vehicle operation data and the vehicle operating status satisfying a preset theme local generation condition, determining the theme generation strategy corresponding to the preset event as a theme local generation strategy.

For example, a theme local generation condition and a theme cloud generation condition may be pre-stored in the electronic device. The theme local generation condition is used for the electronic device to determine whether the processing unit (such as the NPU or the GPU) of the intelligent driving vehicle may be used to generate the theme asset corresponding to the preset event. The theme cloud generation condition is used for the electronic device to determine whether the cloud server needs to be used to generate the theme asset corresponding to the preset event. The vehicle operation data may include one or more of the in-vehicle operation data (such as the in-vehicle load rate and the in-vehicle wireless signal power) and the vehicle operating status (such as the driving status and the parking status), and may also include other types of vehicle operation data. This is not limited in the embodiments of the present disclosure. Descriptions are made in the embodiments of the present disclosure by using an example in which the in-vehicle operation data includes the in-vehicle load rate and the in-vehicle wireless signal power, and the vehicle operating status includes the driving status and the parking status. Other cases are similar thereto, and details are not described in the embodiments of the present disclosure.

When the electronic device uses the theme local generation strategy to generate the theme asset corresponding to the preset event, a large amount of computational resources of the processing unit of the intelligent driving vehicle needs to be occupied. Therefore, when the in-vehicle load rate of the intelligent driving vehicle is low and the intelligent driving vehicle is in the parking status, the electronic device may use the theme local generation strategy to generate the theme asset corresponding to the preset event, thereby avoiding adverse effects on the driving safety of the intelligent driving vehicle. Meanwhile, the electronic device using the theme local generation strategy to generate the theme asset corresponding to the preset event has low network requirements for the intelligent driving vehicle. Based on this, the theme local generation condition may be set as the in-vehicle load rate being less than or equal to a preset in-vehicle load rate threshold, and the vehicle operating status being the parking status. After obtaining the in-vehicle operation data and the vehicle operating status, the electronic device may further determine whether the in-vehicle load rate is less than or equal to the preset in-vehicle load rate threshold and whether the vehicle operating status is the parking status. If the in-vehicle load rate is less than or equal to the preset in-vehicle load rate threshold and the vehicle operating status is the parking status, the electronic device determines that the theme generation strategy corresponding to the preset event is the theme local generation strategy.

Step 402: In response to the in-vehicle operation data or the vehicle operating status satisfying a theme cloud generation condition, determining the theme generation strategy corresponding to the preset event as a theme cloud generation strategy.

For example, when the electronic device uses the theme cloud generation strategy to generate the theme asset corresponding to the preset event, data transmission between the electronic device and the cloud server (such as uploading the theme generation element corresponding to the preset event and downloading the theme asset corresponding to the preset event) is required. This requires the intelligent driving vehicle to have good network connectivity (that is, high in-vehicle wireless signal power). When unable to use the theme local generation strategy to generate the theme asset corresponding to the preset event, the electronic device may use the theme cloud generation strategy to generate the theme asset corresponding to the preset event. Based on this, the theme cloud generation condition may be set as the in-vehicle load rate being greater than the preset in-vehicle load rate threshold and/or the vehicle operating status being the driving status, and the in-vehicle wireless signal power being greater than or equal to a preset in-vehicle wireless signal power threshold. After obtaining the in-vehicle operation data and the vehicle operating status, the electronic device may further determine whether the in-vehicle load rate is greater than the preset in-vehicle load rate threshold and/or whether the vehicle operating status is the driving status, and whether the in-vehicle wireless signal power is greater than or equal to the preset in-vehicle wireless signal power threshold. If the in-vehicle load rate is greater than the preset in-vehicle load rate threshold and/or the vehicle operating status is the driving status, and the in-vehicle wireless signal power is greater than or equal to the preset in-vehicle wireless signal power threshold, the electronic device determines the theme generation strategy corresponding to the preset event as the theme cloud generation strategy.

It should be noted that, in addition to the in-vehicle operation data or the vehicle driving status described above, the electronic device may also set the theme local generation condition and the theme cloud generation condition by comprehensively considering other factors such as complexity in theme asset generation, a personalization degree of the theme asset, and authorization and verification of the theme asset, which is not limited in the embodiments of the present disclosure. Meanwhile, the electronic device may also use the theme local generation strategy in combination with the theme cloud generation strategy to generate the theme asset corresponding to the preset event, which is also not limited in the embodiments of the present disclosure.

In the embodiments of the present disclosure, the electronic device determines the theme generation strategy corresponding to the preset event as the theme local generation strategy or as the theme cloud generation strategy, based on the in-vehicle operation data and the vehicle operating status,, thereby improving flexibility and reliability of theme asset generation.

In some embodiments, as shown in FIG. 5, on the basis of the embodiment shown in FIG. 2, step 203 may include the following steps.

Step 501: In response to the theme generation strategy being a theme cloud generation strategy, transmitting a theme generation request message carrying the theme generation element to a cloud server.

For example, in a case where the electronic device determines the theme generation strategy corresponding to the preset event as the theme cloud generation strategy, the electronic device may transmit the theme generation request message to the cloud server. The theme generation request message carries the theme generation element corresponding to the preset event that is obtained by the electronic device; and is used to instruct the cloud server to generate the theme asset corresponding to the preset event based on the theme generation element corresponding to the preset event.

Step 502: Receiving a theme generation response message sent by the cloud server and carrying an asset storage path of the theme asset, and downloading the theme asset from the cloud server based on the asset storage path, wherein the theme asset is generated by the cloud server based on the theme generation element.

For example, after receiving the theme generation request message sent by the electronic device, the cloud server may decode the theme generation request message to obtain the theme generation element carried in the theme generation request message. Subsequently, the cloud service may invoke a pre-trained general-purpose generative large model to generate theme asset corresponding to the preset event based on the theme generation element corresponding to the preset event. Thereafter, the cloud server may store the theme asset corresponding to the preset event in a storage of the cloud server, and send the theme generation response message to the electronic device. The theme generation response message carries the asset storage path of the theme asset, and is used to instruct the electronic device to download the theme asset corresponding to the preset event based on the asset storage path of the theme asset. After receiving the theme generation response message sent by the cloud server, the electronic device may decode the theme generation response message to obtain the asset storage path carried in the theme generation response message. Subsequently, the electronic device may download the theme asset corresponding to the preset event from the cloud server based on the asset storage path. Subsequently, after obtaining the theme asset corresponding to the preset event, the electronic device may further preload the theme asset corresponding to the preset event into the internal memory of the in-vehicle system, waiting to be invoked.

In the embodiments of the present disclosure, the electronic device transmits the theme generation request message carrying the theme generation element to the cloud server. The cloud server generates the theme asset corresponding to the preset event based on the theme generation element carried in the theme generation request message, and sends the theme generation response message carrying the asset storage path of the theme asset to the electronic device. The electronic device downloads the theme asset corresponding to the preset event from the cloud server based on the asset storage path. In this way, when unable to generate the theme asset corresponding to the preset event by using the processing unit of the intelligent driving vehicle, the electronic device may generate the theme asset corresponding to the preset event by using the cloud server, thereby ensuring timeliness of generating the theme asset corresponding to the preset event.

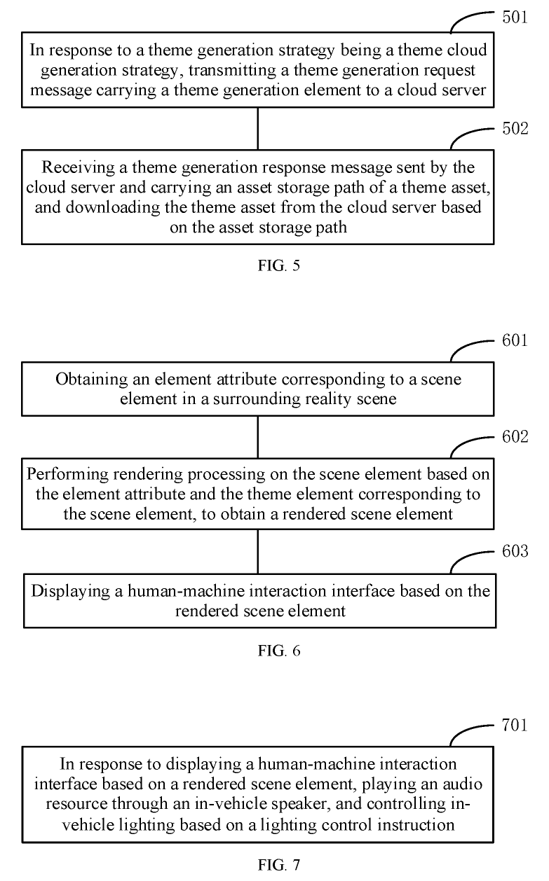

In some embodiments, as shown in FIG. 6, on the basis of the embodiment shown in FIG. 2, the theme asset includes a theme element corresponding to a scene element in a surrounding reality scene. Step 204 may include the following steps.

Step 601: Obtaining an element attribute corresponding to the scene element in the surrounding reality scene.

For example, the theme asset may include the theme element corresponding to the scene element in the surrounding reality scene. The scene element in the surrounding reality scene refers to various physical entities that constitute the surrounding reality scene, can be perceived by a sensor, and are displayed in the human-machine interaction interface. The scene element in the surrounding reality scene may include an ego vehicle, other vehicles, pedestrians, cyclists, buildings, roads, and the like, which are not limited in the embodiments of the present disclosure. The processing unit of the intelligent driving vehicle itself or the cloud server may generate, based on the theme generation element corresponding to the preset event, the theme element corresponding to the scene element in the surrounding reality scene, to obtain the theme asset. For example, a three-dimensional model for the ego vehicle, a three-dimensional model for the other vehicles, a road texture map corresponding to the road, a pendant for a tree, and the like are generated based on the theme generation element corresponding to the preset event. After obtaining the theme element corresponding to the preset event, the electronic device may first obtain the element attribute corresponding to the scene element in the surrounding reality scene. The element attribute corresponding to the scene element refers to a characteristic parameter describing the scene element, and may include a volume (length, width, and height), a location, and the like.

Step 602: Performing rendering processing on the scene element based on the element attribute and the theme element corresponding to the scene element, to obtain a rendered scene element.

For example, after obtaining the element attribute corresponding to the scene element, the electronic device may perform the rendering processing on the scene element based on the element attribute and the theme element corresponding to the scene element, to obtain the rendered scene element. In one embodiment, the electronic device may perform an overall scaling operation on the theme element based on the volume (length, width, and height) in the element attribute corresponding to the scene element, so that a volume of the theme element keeps consistent with that of the scene element. Subsequently, the electronic device may perform the rendering processing on the theme element and the scene element based on a location in the element attribute corresponding to the scene element, to obtain the rendered scene element. For example, taking the preset event being the Dragon Boat Festival as an example, the model for the other vehicles in the surrounding reality scene is rendered as the dragon boat-shaped three-dimensional model for the other vehicles, and zongzi-shaped pendant models are rendered on streetlamps and trees. For another example, taking the preset event being a wedding anniversary as an example, the model for the ego vehicle in the surrounding reality scene is rendered with a stardust light effect and painting of a numeral "V", a tree model is rendered as a wishing tree-shaped tree model, and the sky is rendered as a skybox texture map with a beautiful starry sky and the Milky Way.

Step 603: Displaying a human-machine interaction interface based on the rendered scene element.

For example, after obtaining the rendered scene element, the electronic device may display the human-machine interaction interface based on the rendered scene element. The human-machine interaction interface may be a surrounding reality (SR) visualization interface, an augmented reality head-up display (AR-HUD) visualization interface, or another visualization interface, which is not limited in the embodiments of the present disclosure. For example, taking the augmented reality head-up display visualization interface as an example, in a case where the preset event is the Dragon Boat Festival, the "dragon-boat" shaped three-dimensional model in the theme asset is no longer used to replace the model for the other vehicles in the surrounding reality scene, but serves as a virtual object projected onto a windshield through AR-HUD, to display a realistic dragon boat traveling alongside the ego vehicle in an adjacent lane, or display a giant dragon soaring in the distant sky.

In the embodiments of the present disclosure, after generating the theme asset corresponding to the preset event, the electronic device obtains the element attribute corresponding to scene element in the surrounding reality scene. Subsequently, the electronic device performs the rendering processing on the scene element based on the element attribute and the theme element corresponding to the scene element, to obtain the rendered scene element, and displays the human-machine interaction interface based on the rendered scene element. In this way, the electronic device can dynamically adjust the visual theme style of the human-machine interaction interface based on the preset event, so as to respond to the requirements of the user for personalized and emotionalized experience, thereby improving the driving experience of the user.

In some embodiments, as shown in FIG. 7, on the basis of the embodiment shown in FIG. 2, the theme asset further includes an audio resource and a lighting control instruction. Step 204 may include the following steps.

Step 701: In response to displaying the human-machine interaction interface based on the rendered scene element, playing the audio resource through an in-vehicle speaker, and controlling in-vehicle lighting based on the lighting control instruction.

For example, in addition to the theme element corresponding to the scene element in the surrounding reality scene, the theme asset may also include the audio resource and the lighting control instruction. The audio resource and the lighting control instruction match the preset event. For example, if the preset event is Christmas, the audio resource corresponding to Christmas is an audio resource corresponding to a Christmas song, and the lighting control instruction corresponding to Christmas is a lighting control instruction for controlling lighting to display a snowflake lighting effect. When displaying the human-machine interaction interface based on the rendered scene element, the electronic device may further play the audio resource corresponding to the preset event through the in-vehicle speaker, and control the in-vehicle lighting based on the lighting control instruction corresponding to the preset event. For example, in addition to displaying a reindeer sleigh-shaped three-dimensional model for other vehicles and a Christmas tree-shaped three-dimensional model for trees in the human-machine interaction interface, the electronic device also plays the audio resource corresponding to the Christmas song through the in-vehicle speaker, and controls the lighting based on the lighting control instruction to display the snowflake lighting effect.

In the embodiments of the present disclosure, on the basis of displaying the human-machine interaction interface based on the rendered scene element, the electronic device coordinates sound and lighting to construct multi-modal and full-sensory intelligent cockpit experience integrating visual and auditory senses, thereby creating an all-encompassing ambiance and improving the driving experience of the user.

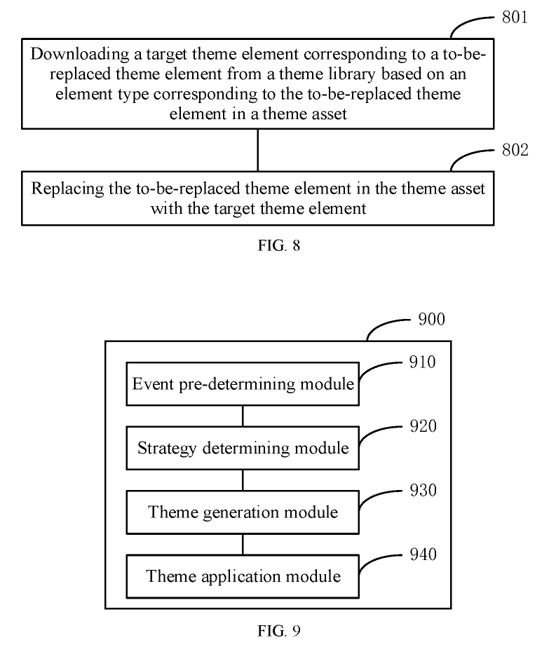

In some embodiments, as shown in FIG. 8, on the basis of the embodiment shown in FIG. 2, the theme application method further includes the following steps.

Step 801: Downloading a target theme element corresponding to a to-be-replaced theme element from a theme library based on an element type corresponding to the to-be-replaced theme element in the theme asset.

For example, after being generated by the processing unit of the intelligent driving vehicle or by the cloud server, the theme element in the theme asset corresponding to the preset event may also be downloaded from the theme library and be replaced. The theme library is an open theme platform to which the user may upload the theme element created thereby, to be used by this user and other users. To be specific, in addition to creating the theme element for own use, the user may also upload the created theme element to the theme library. This user or other users may download and use the theme element from the theme library. For example, a user uploads a three-dimensional building model created thereby to the theme library, and other users may download the three-dimensional building model from the theme library and replace an original three-dimensional building model in the theme asset.

After the theme asset is applied by the electronic device, the user may select a certain theme element (that is, the to-be-replaced theme element) in the human-machine interaction interface and trigger a theme element replacement operation for the to-be-replaced theme element. Accordingly, the electronic device may receive a theme element replacement instruction for the to-be-replaced theme element, and may further obtain the element type of the theme element in response to the theme element replacement instruction for the to-be-replaced theme element. The element type of the theme element indicates a category of the theme element. The element type may include vehicles, buildings, trees, skybox texture maps, road texture maps, pendants, and the like, which is not limited in the embodiments of the present disclosure. Based on the element type corresponding to the to-be-replaced theme element, the electronic device may query the theme library for replaceable theme elements having a same element type as the to-be-replaced theme element, and display the queried replaceable theme elements. The user may select a certain replaceable theme element (that is, the target theme element) from the displayed replaceable theme elements and trigger a theme element confirmation operation for the target theme element. Accordingly, the electronic device may receive a theme element confirmation instruction for the target theme element, and download the target theme element from the theme library.

Step 802: Replacing the to-be-replaced theme element in the theme asset with the target theme element.

For example, after downloading the target theme element from the theme library, the electronic device may replace the to-be-replaced theme element in the theme asset with the target theme element.

In the embodiments of the present disclosure, in addition to creating the theme element for own use, the user may also upload the created theme element to the theme library for other users to download and use. In this way, by actively granting content creation permission to the user, deep requirements of the user for personalization may be met, thereby further improving the driving experience of the user.

### Exemplary Apparatus

FIG. 9 is a schematic diagram illustrating a structure of a theme application apparatus according to an exemplary embodiment of the present disclosure. As shown in FIG. 9, a theme application apparatus 900 includes an event pre-determining module 910, a strategy determining module 920, a theme generation module 930, and a theme application module 940.

The event pre-determining module 910 is configured to, in response to a pre-trigger condition of a preset event being satisfied, obtain vehicle operation data and a theme generation element corresponding to the preset event.

The strategy determining module 920 is configured to determine a theme generation strategy corresponding to the preset event based on the vehicle operation data.

The theme generation module 930 is configured to generate a theme asset corresponding to the preset event by using the theme generation strategy based on the theme generation element, and preload the theme asset into an internal memory of an in-vehicle system.

The theme application module 940 is configured to, in response to a pre-trigger condition of the preset event being satisfied, invoke the preloaded theme asset from the internal memory of the in-vehicle system, and apply the theme asset.

In some embodiments, the event pre-determining module 910 includes:
a first event pre-determining unit, configured to, in response to a time interval between a current date and a trigger date corresponding to the preset event being less than or equal to a preset time interval threshold, obtain the vehicle operation data and the theme generation element corresponding to the preset event; or
a second event pre-determining unit, configured to, in response to a destination being within a trigger area range corresponding to the preset event, obtain the vehicle operation data and the theme generation element corresponding to the preset event; or
a third event pre-determining unit, configured to, in response to an event type of the preset event being an uncertain event type and the preset event satisfying a predicted occurrence condition, obtain the vehicle operation data and the theme generation element corresponding to the preset event.

In some embodiments, the vehicle operation data includes one or more of in-vehicle operation data and a vehicle operating status, and the strategy determining module 920 includes:
a first strategy determining unit, configured to, in response to the in-vehicle operation data and the vehicle operating status satisfying a preset theme local generation condition, determine that the theme generation strategy corresponding to the preset event is a theme local generation strategy; and
a second strategy determining unit, configured to, in response to the in-vehicle operation data or the vehicle operating status satisfying a theme cloud generation condition, determine that the theme generation strategy corresponding to the preset event is a theme cloud generation strategy.

In some embodiments, the theme generation module 930 includes:
a theme generation request transmitting unit, configured to, in response to the theme generation strategy being the theme cloud generation strategy, transmit a theme generation request message carrying the theme generation element to a cloud server; and
a theme asset downloading unit, configured to receive a theme generation response message sent by the cloud server and carrying an asset storage path of the theme asset, and to download the theme asset from the cloud server based on the asset storage path, where the theme asset is generated by the cloud server based on the theme generation element.

In some embodiments, the theme asset includes a theme element corresponding to a scene element in a surrounding reality scene, and the theme application module 940 includes:
an element attribute obtaining unit, configured to obtain an element attribute corresponding to the scene element in the surrounding reality scene;
a scene element rendering unit, configured to perform rendering processing on the scene element based on the element attribute and the theme element corresponding to the scene element, to obtain a rendered scene element; and
a human-machine interaction interface display unit, configured to display a human-machine interaction interface based on the rendered scene element.

In some embodiments, the theme asset further includes an audio resource and a lighting control instruction, and the theme application module 940 includes:
a vehicle control unit, configured to, in response to displaying the human-machine interaction interface based on the rendered scene element, play the audio resource through an in-vehicle speaker, and control in-vehicle lighting based on the lighting control instruction.

In some embodiments, the apparatus further includes:
a theme element downloading module, configured to download a target theme element corresponding to a to-be-replaced theme element from a theme library based on an element type corresponding to the to-be-replaced theme element in the theme asset; and
a theme element replacing module, configured to replace the to-be-replaced theme element in the theme asset with the target theme element.

For beneficial technical effects corresponding to the exemplary embodiment of the present apparatus, refer to the corresponding beneficial technical effects in the exemplary method section described above, and details are not described herein.

### Exemplary Electronic Device

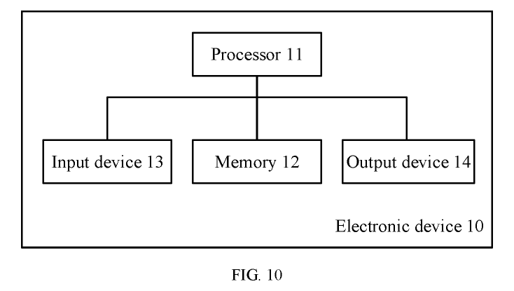

FIG. 10 is a diagram illustrating a structure of an electronic device according to an embodiment of the present disclosure, including at least one processor 11 and a memory 12.

The processor 11 may be a central processing unit (CPU) or another form of processing unit having a data processing capability and/or an instruction execution capability, and may control another component in an electronic device 10 to perform a desired function.

The memory 12 may include one or more computer program products. The computer program product may include various forms of computer-readable storage media, such as a volatile memory and/or a non-volatile memory. The volatile memory may include, for example, a random access memory (RAM) and/or a cache. The non-volatile memory may include, for example, a read-only memory (ROM), a hard disk, or a flash memory. One or more computer program instructions may be stored on the computer-readable storage media, and the processor 11 may run the one or more computer program instructions to implement the theme application method and/or other desired functions of the foregoing embodiments of the present disclosure.

In one example, the electronic device 10 may further include: an input device 13 and an output device 14. These components are interconnected through a bus system and/or other forms of connection mechanisms (not shown).

The input device 13 may further include, for example, a keyboard or a mouse.

The output device 14 may output various information to the outside, and may include, for example, a display, a speaker, a printer, a communication network, and a remote output device connected to the communication network.

Certainly, for simplicity, FIG. 10 only shows some of the components in the electronic device 10 that are related to the present disclosure, and components such as buses and an input/output interface are omitted. In addition, depending on specific applications, the electronic device 10 may also include any other appropriate components.

Exemplary Computer Program Product and Computer-Readable Storage Medium

In addition to the foregoing methods and devices, embodiments of the present disclosure may also provide a computer program product including computer program instructions that, when run by a processor, cause the processor to perform the steps in the theme application method of the various embodiments of the present disclosure described in the foregoing "Exemplary Method" section.

The computer program product may be program code, written with one or any combination of a plurality of programming languages, that is configured for performing the operations in the embodiments of the present disclosure. The programming languages include an object-oriented programming language such as Java or C++, and further includes a conventional procedural programming language such as a "C" language or a similar programming language. The program code may be entirely or partially executed on a user computing device, executed as an independent software package, partially executed on a user computing device and partially executed on a remote computing device, or entirely executed on the remote computing device or a server.

In addition, the embodiments of the present disclosure may further relate to a computer-readable storage medium, on which computer program instructions are stored. The computer program instructions, when run by a processor, cause the processor to perform the steps in the theme application method of the various embodiments of the present disclosure described in the foregoing "Exemplary Method" section.

The computer-readable storage medium may be one readable medium or any combination of a plurality of readable media. The readable medium may be a readable signal medium or a readable storage medium. The readable storage medium includes, for example but not limited to, electrical, magnetic, optical, electromagnetic, infrared, or semiconductor systems, apparatuses, or devices, or any combination of the above. More specific examples (a non-exhaustive list) of the readable storage media include: an electrical connection having one or more conducting wires, a portable disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above.

Basic principles of the present disclosure are described above in combination with specific embodiments. However, the advantages, superiorities, and effects mentioned in the present disclosure are merely examples rather than limitations, and it should not be considered that these advantages, superiorities, and effects are necessary for the embodiments of the present disclosure. In addition, the specific details disclosed above are merely for examples and for ease of understanding, rather than for limitations. The details described above do not limit the present disclosure to necessarily adopting the foregoing specific details for implementation.

A person skilled in the art may make various modifications and variations to the present disclosure without departing from the spirit and the scope of the present disclosure. In this way, if these modifications and variations of the present disclosure fall within the scope of the claims and equivalent technologies of the claims of the present disclosure, the present disclosure also intends to include these modifications and variations.

What is claimed is:

1. A theme application method, comprising:
in response to a pre-trigger condition of a preset event being satisfied, obtaining vehicle operation data and a theme generation element corresponding to the preset event;
determining a theme generation strategy corresponding to the preset event based on the vehicle operation data;
generating a theme asset corresponding to the preset event by using the theme generation strategy based on the theme generation element, and preloading the theme asset into an internal memory of an in-vehicle system; and
in response to a pre-trigger condition of the preset event being satisfied, invoking the preloaded theme asset from the internal memory of the in-vehicle system, and applying the theme asset.

2. The method according to claim 1, wherein the in response to a pre-trigger condition of a preset event being satisfied, obtaining vehicle operation data and a theme generation element corresponding to the preset event comprises:
in response to a time interval between a current date and a trigger date corresponding to the preset event being less than or equal to a preset time interval threshold, obtaining the vehicle operation data and the theme generation element corresponding to the preset event; or
in response to a destination being within a trigger area range corresponding to the preset event, obtaining the vehicle operation data and the theme generation element corresponding to the preset event; or
in response to an event type of the preset event being an uncertain event type and the preset event satisfying a predicted occurrence condition, obtaining the vehicle operation data and the theme generation element corresponding to the preset event.

3. The method according to claim 1, wherein the vehicle operation data comprises one or more of in-vehicle operation data and a vehicle operating status, and the determining a theme generation strategy corresponding to the preset event based on the vehicle operation data comprises:
in response to the in-vehicle operation data and the vehicle operating status satisfying a preset theme local generation condition, determining that the theme generation strategy corresponding to the preset event is a theme local generation strategy; and
in response to the in-vehicle operation data or the vehicle operating status satisfying a theme cloud generation condition, determining that the theme generation strategy corresponding to the preset event is a theme cloud generation strategy.

4. The method according to claim 3, wherein the generating a theme asset corresponding to the preset event by using the theme generation strategy based on the theme generation element comprises:
in response to the theme generation strategy being the theme cloud generation strategy, transmitting a theme generation request message carrying the theme generation element to a cloud server; and
receiving a theme generation response message sent by the cloud server and carrying an asset storage path of the theme asset, and downloading the theme asset from the cloud server based on the asset storage path, wherein the theme asset is generated by the cloud server based on the theme generation element.

5. The method according to claim 1, wherein the theme asset comprises a theme element corresponding to a scene element in a surrounding reality scene, and the applying the theme asset comprises:
obtaining an element attribute corresponding to the scene element in the surrounding reality scene;
performing rendering processing on the scene element based on the element attribute and the theme element corresponding to the scene element, to obtain a rendered scene element; and
displaying a human-machine interaction interface based on the rendered scene element.

6. The method according to claim 5, wherein the theme asset further comprises an audio resource and a lighting control instruction, and the applying the theme asset comprises:
in response to displaying the human-machine interaction interface based on the rendered scene element, playing the audio resource through an in-vehicle speaker, and controlling in-vehicle lighting based on the lighting control instruction.

7. The method according to claim 1, wherein before the applying the theme asset, the method further comprises:
downloading a target theme element corresponding to a to-be-replaced theme element from a theme library based on an element type corresponding to the to-be-replaced theme element in the theme asset; and
replacing the to-be-replaced theme element in the theme asset with the target theme element.

8. A non-transitory computer-readable storage medium, on which a computer program is stored, wherein the computer program, when executed by a processor, causes the processor to implement a theme application method, wherein the method comprise:
in response to a pre-trigger condition of a preset event being satisfied, obtaining vehicle operation data and a theme generation element corresponding to the preset event;
determining a theme generation strategy corresponding to the preset event based on the vehicle operation data;
generating a theme asset corresponding to the preset event by using the theme generation strategy based on the theme generation element, and preloading the theme asset into an internal memory of an in-vehicle system; and
in response to a pre-trigger condition of the preset event being satisfied, invoking the preloaded theme asset from the internal memory of the in-vehicle system, and applying the theme asset.

9. The non-transitory computer-readable storage medium according to claim 8, wherein the in response to a pre-trigger condition of a preset event being satisfied, obtaining vehicle operation data and a theme generation element corresponding to the preset event comprises:
in response to a time interval between a current date and a trigger date corresponding to the preset event being less than or equal to a preset time interval threshold, obtaining the vehicle operation data and the theme generation element corresponding to the preset event; or
in response to a destination being within a trigger area range corresponding to the preset event, obtaining the vehicle operation data and the theme generation element corresponding to the preset event; or
in response to an event type of the preset event being an uncertain event type and the preset event satisfying a predicted occurrence condition, obtaining the vehicle operation data and the theme generation element corresponding to the preset event.

10. The non-transitory computer-readable storage medium according to claim 8, wherein the vehicle operation data comprises one or more of in-vehicle operation data and a vehicle operating status, and the determining a theme generation strategy corresponding to the preset event based on the vehicle operation data comprises:
in response to the in-vehicle operation data and the vehicle operating status satisfying a preset theme local generation condition, determining that the theme generation strategy corresponding to the preset event is a theme local generation strategy; and
in response to the in-vehicle operation data or the vehicle operating status satisfying a theme cloud generation condition, determining that the theme generation strategy corresponding to the preset event is a theme cloud generation strategy.

11. The non-transitory computer-readable storage medium according to claim 10, wherein the generating a theme asset corresponding to the preset event by using the theme generation strategy based on the theme generation element comprises:
in response to the theme generation strategy being the theme cloud generation strategy, transmitting a theme generation request message carrying the theme generation element to a cloud server; and
receiving a theme generation response message sent by the cloud server and carrying an asset storage path of the theme asset, and downloading the theme asset from the cloud server based on the asset storage path, wherein the theme asset is generated by the cloud server based on the theme generation element.

12. The non-transitory computer-readable storage medium according to claim 8, wherein the theme asset comprises a theme element corresponding to a scene element in a surrounding reality scene, and the applying the theme asset comprises:
obtaining an element attribute corresponding to the scene element in the surrounding reality scene;
performing rendering processing on the scene element based on the element attribute and the theme element corresponding to the scene element, to obtain a rendered scene element; and
displaying a human-machine interaction interface based on the rendered scene element.

13. The non-transitory computer-readable storage medium according to claim 12, wherein the theme asset further comprises an audio resource and a lighting control instruction, and the applying the theme asset comprises:
in response to displaying the human-machine interaction interface based on the rendered scene element, playing the audio resource through an in-vehicle speaker, and controlling in-vehicle lighting based on the lighting control instruction.

14. An electronic device, wherein the electronic device comprises:
a processor; and
a memory configured to store instructions executable by the processor, wherein
the processor is configured to read the executable instructions from the memory, and execute the instructions to implement a theme application method, wherein the method comprises:
in response to a pre-trigger condition of a preset event being satisfied, obtaining vehicle operation data and a theme generation element corresponding to the preset event;
determining a theme generation strategy corresponding to the preset event based on the vehicle operation data;
generating a theme asset corresponding to the preset event by using the theme generation strategy based on the theme generation element, and preloading the theme asset into an internal memory of an in-vehicle system; and
in response to a pre-trigger condition of the preset event being satisfied, invoking the preloaded theme asset from the internal memory of the in-vehicle system, and applying the theme asset.

15. The electronic device according to claim 14, wherein the in response to a pre-trigger condition of a preset event being satisfied, obtaining vehicle operation data and a theme generation element corresponding to the preset event comprises:
in response to a time interval between a current date and a trigger date corresponding to the preset event being less than or equal to a preset time interval threshold, obtaining the vehicle operation data and the theme generation element corresponding to the preset event; or
in response to a destination being within a trigger area range corresponding to the preset event, obtaining the vehicle operation data and the theme generation element corresponding to the preset event; or
in response to an event type of the preset event being an uncertain event type and the preset event satisfying a predicted occurrence condition, obtaining the vehicle operation data and the theme generation element corresponding to the preset event.

16. The electronic device according to claim 14, wherein the vehicle operation data comprises one or more of in-vehicle operation data and a vehicle operating status, and the determining a theme generation strategy corresponding to the preset event based on the vehicle operation data comprises:
in response to the in-vehicle operation data and the vehicle operating status satisfying a preset theme local generation condition, determining that the theme generation strategy corresponding to the preset event is a theme local generation strategy; and
in response to the in-vehicle operation data or the vehicle operating status satisfying a theme cloud generation condition, determining that the theme generation strategy corresponding to the preset event is a theme cloud generation strategy.

17. The electronic device according to claim 16, wherein the generating a theme asset corresponding to the preset event by using the theme generation strategy based on the theme generation element comprises:
in response to the theme generation strategy being the theme cloud generation strategy, transmitting a theme generation request message carrying the theme generation element to a cloud server; and
receiving a theme generation response message sent by the cloud server and carrying an asset storage path of the theme asset, and downloading the theme asset from the cloud server based on the asset storage path, wherein the theme asset is generated by the cloud server based on the theme generation element.

18. The electronic device according to claim 14, wherein the theme asset comprises a theme element corresponding to a scene element in a surrounding reality scene, and the applying the theme asset comprises:
obtaining an element attribute corresponding to the scene element in the surrounding reality scene;
performing rendering processing on the scene element based on the element attribute and the theme element corresponding to the scene element, to obtain a rendered scene element; and
displaying a human-machine interaction interface based on the rendered scene element.

19. The electronic device according to claim 18, wherein the theme asset further comprises an audio resource and a lighting control instruction, and the applying the theme asset comprises:
in response to displaying the human-machine interaction interface based on the rendered scene element, playing the audio resource through an in-vehicle speaker, and controlling in-vehicle lighting based on the lighting control instruction.

20. The electronic device according to claim 14, wherein before the applying the theme asset, the method further comprises:
downloading a target theme element corresponding to a to-be-replaced theme element from a theme library based on an element type corresponding to the to-be-replaced theme element in the theme asset; and
replacing the to-be-replaced theme element in the theme asset with the target theme element.
